(19) United States
(12) Patent Application Publication
(10) Pub. No.: US 2016/0131304 A1
(43) Pub. Date: May 12, 2016

(54) DRYWALL BRACE AND METHOD FOR INSTALLING

(71) Applicant: James Roberts, San Tan Valley, AZ (US)

(72) Inventor: James Roberts, San Tan Valley, AZ (US)

(21) Appl. No.: 14/059,473

(22) Filed: Oct. 22, 2013

(51) Int. Cl. F16M 13/02; E04B 9/00

(52) U.S. Cl. CPC F16M 13/02; E04B 9/006

(57) ABSTRACT

A drywall brace that is a bar that is flattened on at least one side, with a thin, line or wire such as a multi-strand wire strategically attached on both sides of a mounting aperture in the bar. The thin strand wires are at least as long as two-thirds of the length of the bar. The drywall brace is pushed through an aperture in the sheet of drywall lengthwise, either end first. The flat side of the drywall brace is positioned against the sheet of drywall. The thin line or wire is utilized to position the drywall brace and to hold the thin line or wire until a fastener such as a screw is mounted into the drywall brace. Prior to inserting the drywall brace through the sheet of drywall, a pilot aperture is drilled into the drywall brace midway between the mounting locations of the thin line or wire.

### BACKGROUND OF THE INVENTION

1. Field of the Invention

The present invention is a brace. More specifically, the present invention is a drywall brace and method for installing.

2. Description of the Related Art

In some drywall applications, anchors are screwed into a sheet of drywall providing minimal fortification. In other applications, toggle bolts are pushed through the sheet of drywall providing slightly wider distribution of the fortification but still far less than the drywall brace. These applications produce a relatively large aperture in the sheet of drywall and are also structurally not particularly strong.

The present invention solves these problems by providing a drywall brace that does not produce a relatively large aperture in the sheet of drywall and is structurally stronger than traditional drywall brace applications.

### BRIEF SUMMARY OF THE INVENTION

The present invention is a brace. More specifically, the present invention is a drywall brace and method for installing.

The drywall brace is a bar that is flattened on at least one side, with a thin, line or wire such as a multi-strand wire strategically attached on both sides of a mounting aperture in the bar. The thin strand wires are at least as long as two-thirds of the length of the bar. The diameter of the bar is scalable depending on the size aperture desired in the sheet of drywall. The length of the bar is scalable depending on the amount of fortification desired and the amount of clearance space behind the sheet of drywall. The material of the bar is variable, depending on the strength desired.

The drywall brace is pushed through an aperture in the sheet of drywall lengthwise, either end first. The flat side of the drywall brace is positioned against the sheet of drywall. The thin line or wire such as a multi-strand wire is utilized to position the drywall brace and to hold it until a screw is mounted into the drywall brace. Prior to inserting the drywall brace through the sheet of drywall, a pilot aperture is drilled into the drywall brace midway between the mounting locations of the thin line or wire such as a multi-strand wire.

Many cavities such as in an attic, easily allow a bar of 12 inches or greater to be utilized. The result is the drywall brace distributes the stress of the appliance being mounted to a very wide area of the sheet of drywall providing significant higher fortification over traditional methods with minimal disturbance to the aesthetic side of the sheet of drywall. The drywall brace is uncomplicated, but it has wide application and can be mass produced at a relatively low cost. The amount of training to install the drywall brace required is relatively small as well.

If an aperture doesn't already exist in the sheet of drywall then a drywall brace with a pointed and flattened end is utilized to drill an aperture by rotating the pointed and flattened end of the drywall brace. The drywall brace is pushed through an aperture in the sheet of drywall lengthwise. The flat side of the drywall brace is positioned against the sheet of drywall. The thin line or wire such as a multi-strand wire is utilized to position the drywall brace and to hold it until a screw is mounted into the drywall brace.

It is an object of the present invention to provide a drywall brace that enables fortification of a mounting spot on a sheet of drywall without making a large aperture in the sheet of drywall.

It is an object of the present invention to provide a drywall brace that has a pointed and flattened end utilized to drill an aperture in the sheet of drywall by rotating the pointed and flattened end of the brace.

It is an object of the present invention to provide a drywall brace that is uncomplicated, has wide application and can be mass produced at a relatively low cost.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side exploded environmental perspective view of a drywall brace, in accordance with one embodiment of the present invention.

FIG. 2 illustrates a side exploded environmental perspective view of a drywall brace, in accordance with one embodiment of the present invention.

FIG. 3 illustrates a flowchart of a method for installing a drywall brace, in accordance with one embodiment of the present invention.

### DETAILED DESCRIPTION OF ILLUSTRATIVE EMBODIMENTS

Various aspects of the illustrative embodiments will be described utilizing terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

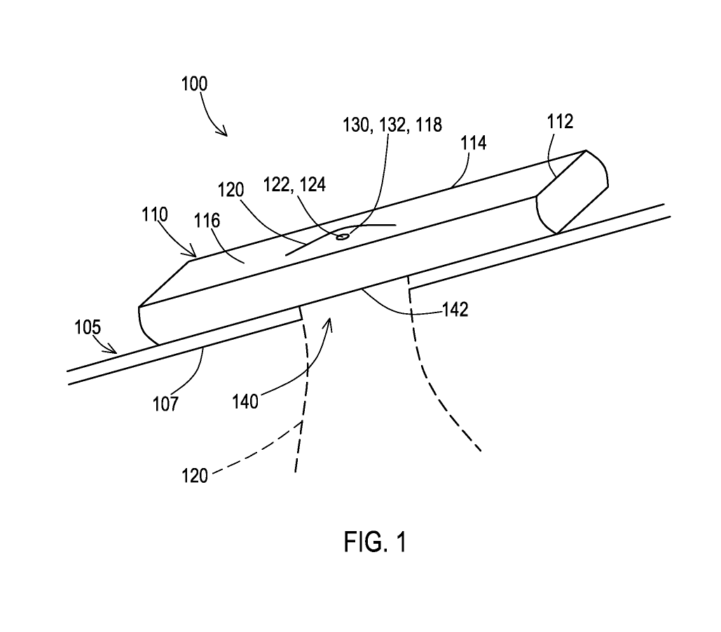

FIG. 1 illustrates a side exploded environmental perspective view of a drywall brace 100, in accordance with one embodiment of the present invention. The drywall brace 100 includes a base bar 110, a line or wire 120 such as a multi-strand wire 121, a mounting aperture 130 and a drywall aperture 140. The base bar 110 has a diameter 112 and a length 114 and is flattened on at least one side 116. The base bar 110 is made of metal, steel, plastic or any other suitable material. The line or wire 120 is at least two-thirds of the length 114 of the base bar 110 or any other suitable length. The length 114 of the base bar 110 is scalable depending on the amount of fortification desired and the amount of clearance space behind the sheet of drywall 105. The greater the length 114 of the base bar 110, the greater the amount of fortification. The line or wire 120 is made of durable metal, steel or other suitable durable material. The mounting aperture 130 is a pilot aperture 132 drilled into the drywall brace 100 on a middle portion 118 of the base bar 110. The line or wire 120 is utilized to secure the drywall brace 100 against a back side 107 of the sheet of drywall 105 to allow a fastener 122 such as a screw 124 to be placed into the pilot aperture 132. The fastener 122 is slightly larger than the pilot aperture 132 to provide a relatively tight fit when placed into the pilot aperture 132. The drywall aperture 140 is made on the sheet of drywall 105 by any suitable method such as drilling. The diameter 112 of the base bar 110 is scalable depending on a diameter 142 of the drywall aperture 140. The greater the diameter 112 of the base bar 110, the greater the diameter 142 of the drywall aperture 140.

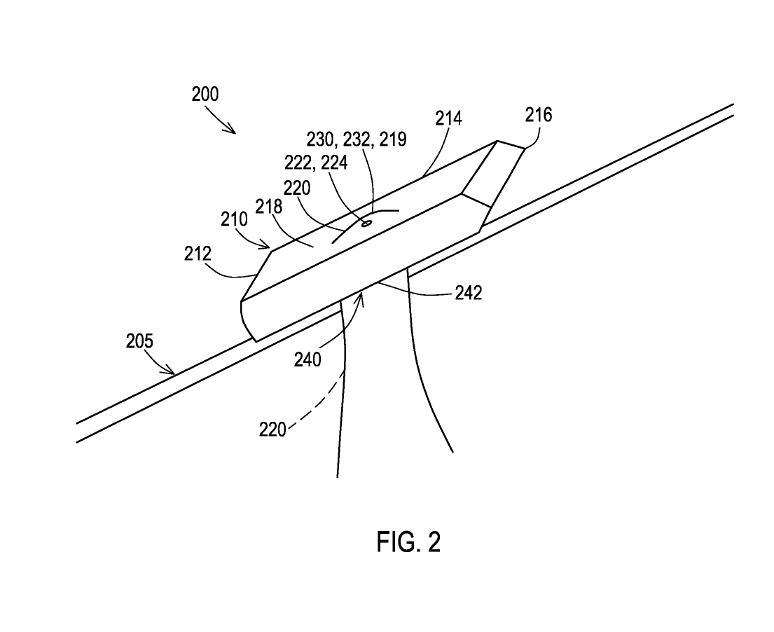

FIG. 2 illustrates a side exploded environmental perspective view of a drywall brace 200, in accordance with one embodiment of the present invention.

The drywall brace 200 includes a base bar 210, a line or wire 220 such as a multi-strand wire 221, a mounting aperture 230 and a drywall aperture 240. The base bar 210 has a diameter 212, a length 214, a pointed end 216 and is flattened on at least one side 218. The base bar 210 is made of metal, plastic or any other suitable material. The line or wire 220 is at least two-thirds of the length 214 of the base bar 210 or any other suitable length. The length 214 of the base bar 210 is scalable depending on the amount of fortification desired and the amount of clearance space behind the sheet of drywall 205. The greater the length 214 of the base bar 210, the greater the amount of fortification. The line or wire 220 is made of durable metal or other suitable durable material. The mounting aperture 230 is a pilot aperture 232 drilled into the drywall brace 200 on a middle portion 219 of the base bar 210. The line or wire 220 is utilized to secure the drywall brace 200 against a back side 207 of the sheet of drywall 205 to allow a fastener 222 such as a screw 224 to be screwed into the pilot aperture 232. The fastener 222 is slightly larger than the pilot aperture 232 to provide a relatively tight fit when placed into the pilot aperture 232. The drywall aperture 240 is produced on the sheet of drywall 205 by rotating the pointed end 216 of the base bar 210 into the sheet of drywall 205. The diameter 212 of the base bar 210 is scalable depending on a diameter 242 of the drywall aperture 240. The greater the diameter 212 of the base bar 210, the greater the diameter 242 of the drywall aperture 240.

It is an object of the present invention to provide a drywall brace that enables fortification of a mounting spot on a sheet of drywall without making a large aperture in the sheet of drywall.

It is an object of the present invention to provide a drywall brace that has a pointed and flattened end utilized to drill an aperture in the sheet of drywall by rotating the pointed and flattened end of the brace.

It is an object of the present invention to provide a drywall brace that is uncomplicated, has wide application and can be mass produced at a relatively low cost.

Use of the drywall brace 200 is straightforward. The drywall brace 200 is pushed through a drywall aperture 240, either ends first. The flat side of the drywall brace 200 is positioned against the sheet of drywall 205. The line or wire 220 is used to position the drywall brace 200 and to hold it until the fastener 222 such as a screw 224 is mounted into the drywall brace 200. Prior to inserting the drywall brace 200 through the sheet of drywall 205, a pilot aperture 232 is drilled into the sheet of drywall brace 200 midway between the mounting locations of the line or wire 220. Many cavities, such as an attic, easily allow a base bar 210 of 12 inches or greater to be used. The result is the drywall brace 200 distributes the stress of the appliance being mounted to a very wide area of the sheet of drywall 205 providing significant higher fortification over traditional methods with minimal disturbance to the aesthetic side of the sheet of drywall 205.

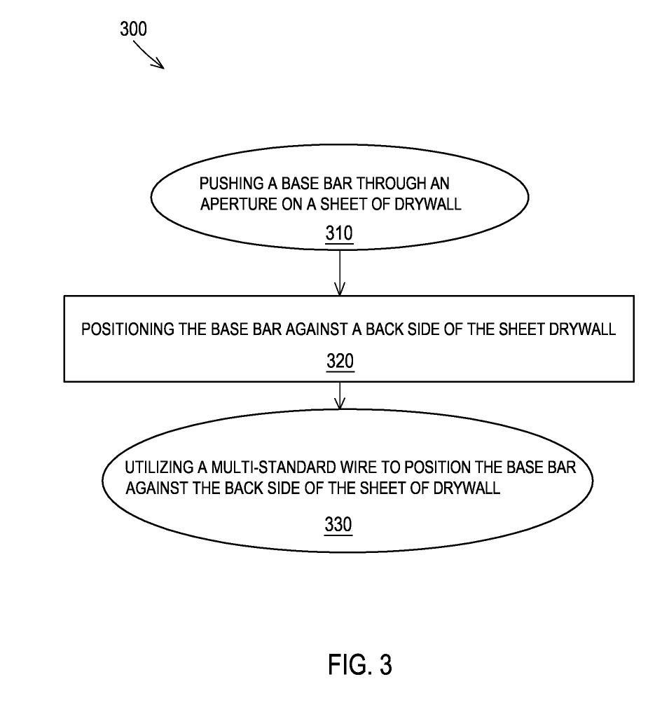

FIG. 3 illustrates a flowchart of a method 300 for installing a drywall brace, in accordance with one embodiment of the present invention.

The method 300 includes the steps of pushing a drywall brace through an aperture on a sheet of drywall 310, positioning the drywall brace against a back side of the sheet of drywall 320 and utilizing a line or wire such as a multi-strand wire to position the drywall brace 330. The pushing the drywall brace through an aperture in the sheet of drywall 310 step includes pushing either end of the drywall brace through the aperture in the sheet of drywall. The positioning the drywall brace against a back side of the sheet of drywall 320 step includes securing the drywall brace to allow a fastener such as a screw to be inserted into a pilot aperture disposed on a middle portion of a base bar of the drywall brace. The positioning the drywall brace against a back side of the sheet of drywall 320 step includes the drywall brace with a pointed end to make a pilot aperture on the middle portion of the base bar of the drywall brace. The utilizing the line or wire to position the drywall brace 330 step includes the line or wire protruding through the aperture exterior to the sheet of drywall.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A drywall brace, comprising:
a base bar with a diameter and a length, the base bar is flattened on at least one side;
a line or wire utilized to secure the base bar against a back side of a sheet of drywall;
a mounting aperture drilled on a middle portion of the base bar; and
a drywall aperture produced on the sheet of drywall, the base bar pushed through the drywall aperture before secured against the back side of the sheet of drywall by the line or wire.

2. The drywall brace according to claim 1, wherein the base bar is made of material selected from the group consisting of metal, steel or plastic.

3. The drywall brace according to claim 1, wherein the line or wire is made of metal.

4. The drywall brace according to claim 3, wherein the line or wire is a multi-strand wire.

5. The drywall brace according to claim 1, wherein the mounting aperture is a pilot aperture.

6. The drywall brace according to claim 5, further comprising a fastener placed into the pilot aperture.

7. The drywall brace according to claim 6, wherein the fastener is larger than the pilot aperture to provide a tight fit when the fastener is placed into the pilot aperture.

8. The drywall brace according to claim 7, wherein the fastener is a screw.

9. The drywall brace according to claim 1, wherein the drywall aperture produced on the sheet of drywall is produced by drilling.

10. A drywall brace, comprising:
a base bar with a diameter, a length and a pointed end, the base bar is flattened on at least one side;
a steel line or wire utilized to secure the base bar against a back side of a sheet of drywall;
a mounting aperture drilled on a middle portion of the base bar; and
a drywall aperture produced on the sheet of drywall, the base bar pushed through the drywall aperture before secured against the back side of the sheet of drywall by the line or wire.

11. The drywall brace according to claim 10, wherein the base bar is made of material selected from the group consisting of metal, steel or plastic.

12. The drywall brace according to claim 10, wherein the line or wire is a multi-strand wire.

13. The drywall brace according to claim 10, wherein the mounting aperture is a pilot aperture.

14. The drywall brace according to claim 13, further comprising a fastener placed into the pilot aperture.

15. The drywall brace according to claim 14, wherein the fastener is larger than the pilot aperture to provide a tight fit when the fastener is placed into the pilot aperture.

16. The drywall brace according to claim 15, wherein the fastener is a screw.

17. The drywall brace according to claim 10, wherein the drywall aperture is produced on the sheet of drywall by rotating the pointed end of the base bar into the sheet of drywall.

18. A method for installing a drywall brace, comprising the steps of:
pushing a base bar through an aperture on a sheet of drywall;
positioning the base bar against a back side of the sheet of drywall; and
utilizing a line or wire to position the base bar against the back side of the sheet of drywall.

19. The method according to claim 18, wherein positioning the drywall brace against a back side of the sheet of drywall includes utilizing a drywall brace with a pointed end to make a pilot aperture on a middle portion of the base bar.

20. The method according to claim 18, wherein utilizing the line or wire to position the drywall brace step includes the line or wire protruding through the aperture exterior to the sheet of drywall.
